(19) United States
(12) Patent Application Publication
(10) Pub. No.: US 2024/0119524 A1
(43) Pub. Date: Apr. 11, 2024

(54) MATCHING ENGINE FOR AUTOMATED EXCHANGE OVER COMPUTER NETWORK

(71) Applicant: Forge Global, Inc., San Francisco, CA (US)

(72) Inventors: HsiangLi Wu, Burlingame, CA (US); Patrick M. Sellers, Chicago, IL (US); Michael T. Lippold, Newberg, OR (US); Kevyn E. Herrera, Walnut Creek, CA (US); John T. Huang, Cupertino, CA (US)

(21) Appl. No.: 18/148,989

(22) Filed: Dec. 30, 2022

Related U.S. Application Data
(60) Provisional application No. 63/378,476, filed on Oct. 5, 2022.

(51) Int. Cl. G06Q 40/04; H04L 67/143

(52) U.S. Cl. CPC G06Q 40/04; H04L 67/143

(57) ABSTRACT

A system can receive an indication from a user of a user device to participate in a session of an electronic exchange. The indication includes an indication of interest to perform a transaction with a participant of the temporary session. The system can predict, as an output of a machine learning (ML) model, a range of values for a valuation of the asset, receive an indication that the user selected a particular value of the range of values to configure a first side of the transaction, and automatically match a second side for the transaction with the first side of the transaction. The system further can perform an exchange of the asset between the first side and the second side of the transaction based on the particular value of the range of values.

### CROSS-REFERENCE TO RELATED APPLICATION

This application claims the benefit of U.S. Provisional Application No. 63/378,476, filed Oct. 5, 2022, titled “BIFURCATED CONTROL OF DECOUPLED ASYMMETRIC EXCHANGE OVER COMPUTER NETWORK,” which is incorporated herein by reference in its entirety.

### BACKGROUND

An electronic trading platform is a piece of computer software that allows users to place orders for financial products over a network with an intermediary. Examples of the products include stocks, bonds, currencies, commodities, and derivatives. The platforms are available on mobile devices but can provide a website counterpart or Application Programming Interfaces (APIs). Execution over longer-range networks has caused discrepancies in transaction speeds. The speed of data over the Internet, incurring many network switches, also brings on additional time delays. The execution of a transaction physically closer to an electronic exchange or intermediary executes faster than one further away. Further, the availability of such platforms to the public has encouraged a surge in broad investing, requiring scalability to handle network congestion.

Thus, a platform can administer services or transmit products electronically over computer networks. A characteristic of a platform includes scalability, which refers to the ability of a network to handle increasing workloads in an effective and sustainable way, by expanding the network's bandwidth capacity and supporting expansion of additional users or products. A platform that can efficiently scale avoids network congestion, which refers to the reduced quality of service that occurs when a network node or link is carrying more data than it can handle. Typical effects of network congestion include queueing delay, data loss, or the blocking of new connections. A consequence of congestion is that an incremental increase in the network load leads either only to a small increase or even a decrease in network throughput. Therefore, communications of an electronic exchange with or between entities is complex and can impact and be impacted by performance of a network.

### BRIEF DESCRIPTION OF THE DRAWINGS

Detailed descriptions of implementations of the present technology will be described and explained through the use of the accompanying drawings.

FIG. 1A illustrates an exercise and hold process.

FIG. 1B illustrates an exercise and sell process.

FIG. 1C illustrates a sell to cover process.

FIG. 2 illustrates a system including servers configured to perform bifurcated control of a decoupled asymmetric exchange between devices.

FIG. 3 is a flowchart that illustrates processes including bifurcated control of a decoupled asymmetric exchange between devices.

FIG. 4 is a flowchart that illustrates processes performed by a matching engine to perform exchanges over computer network.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A computer-implemented system includes a matching engine of an electronic market configured to automatically match orders between users participating in an event. The system predicts valuations including properties of assets that are temporarily unknown or undiscoverable and sets the predicted properties to virtualize operations of exchanges between participants. The system does not require manual operations by an intermediary broker and, as such, the system enables large-scale operations for numerous users to participate in an event at various points of entry with orders having a large range of values. Examples of the operations include issuing requests and demands for an alternative to tender while providing desired controls to issuers and other participants. The system can include an interface that provides a guided experience for users participating in an event while validating predicted parameters for the event and executing a rules-based mechanism to check order transactions. The system can dynamically update valuations based on indications of participant interest and includes a managed queue for processing and validating indications of interest (IOIs).

The matching engine can process a trade promotion by converting sell intents to virtual confirmed trades, which obviates the need for human brokers to discover and match orders in private trading. The trades are matched automatically with one or more anchor buyers from the buy-side and sell intents from event participants on the sell-side. The trades are promoted from an order management system (OMS) to an automated trade system (ATS) as matched trades and a term sheet will be created automatically. An OMS can include a software-based platform that uses a standard protocol to facilitate and manage order executions through a standard protocol. OMS systems are used on both buy-side and sell-side, although the functionality provided by buy-side and sell-side differs.

The technology can obviate or reduce transaction limits. For example, private trading normally has low liquidity, which requires human intensive processing to match particular orders that must exceed a threshold value or quantity to justify the prohibitive cost of human intervention. As such, private trading is prohibitive for most participants that cannot reach or exceed the high threshold. As such, a barrier for lower trades sizes (e.g., volumes) and transaction limit (e.g., value) is imposed. The matching engine can thus increase liquidity with numerous (e.g., hundreds, thousands) of small shareholders that can submit small sell intents to be aggregated and fulfill the sell side. As a result, there is no (or reduced) limits of how many shareholders can participate in an event.

A share conversion feature can convert shares without needing the issuer to cancel a first type of share before issuing the second type of share. As such, the system can convert from preferred shares to common shares, preferred A to preferred B, or any other share conversion combinations. The issuer thus does not need to cancel a preferred stock A to reissue common stock to shareholders. Instead, the system can receive preferred share A issued by the issuer and convert the shares to common shares.

The computer-implemented system can host a platform that includes an electronic exchange for users to perform a decoupled asymmetric exchange that exercises options virtually at given values less than current values without initially exchanging the given values during the exchange. As such, the user can liquidate the current value of an option and obtain proceeds without directly exercising the option at the given value. In one example, the platform accepts requests for purchasing equities associated with options and temporarily holds payments from buyers in exchange for equities conditioned on options owned by holders of the options. The holders are invited to participate in a time-restricted session event to liquidate options without needing to exchange given values for current values. Instead, the payments of the purchasers are allocated to exercise the options on behalf of the holders, which bypasses the need for holders to exercise the options in exchange for money (e.g., cash). The platform is scalable for numerous participants in time-restricted events while minimizing network activity required to exercise options.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

The term “option,” as used herein, can refer to a financial instrument that is based on the value of underlying securities such as stocks. An options contract offers a buyer the opportunity to buy or sell the underlying asset. An options contract can have a specific expiration date by which the holder must exercise their option. The stated price on an option is known as the strike price. Options can be bought and sold through an online trading platform. In the context of an electronic trading platform, an option is represented as an electronic element and can be referred to as an element corresponding to a proxy for an asset.

The term “decoupled,” as used herein in the context of an exchange, can refer to having the exchange divided into two or more forks or branches. An exchange refers to a process for trading one thing for another. The decoupled exchange includes two separate asynchronous processes to trade money for assets through intermediary entities that control the exchange in a “bifurcated” manner, to control the exchange with a purchaser device through the electronic platform and an agent. The exchange is “asymmetric” because the two or more processes of the exchange are not necessarily uniform, synchronized, or directly related to each other.

The term “indication of interest” (IOI) refers to a method of messaging in which an IOI is communicated in an electronic message over a network to a system, which directs an IOI message to a targeted user that has an identifiable interest in receiving the IOI message. An IOI conveys a non-binding interest in transacting a trade in a financial market. As such, IOI messages allow participants to query an interest for buying or selling a share in a market without having to place visible orders on an order book.

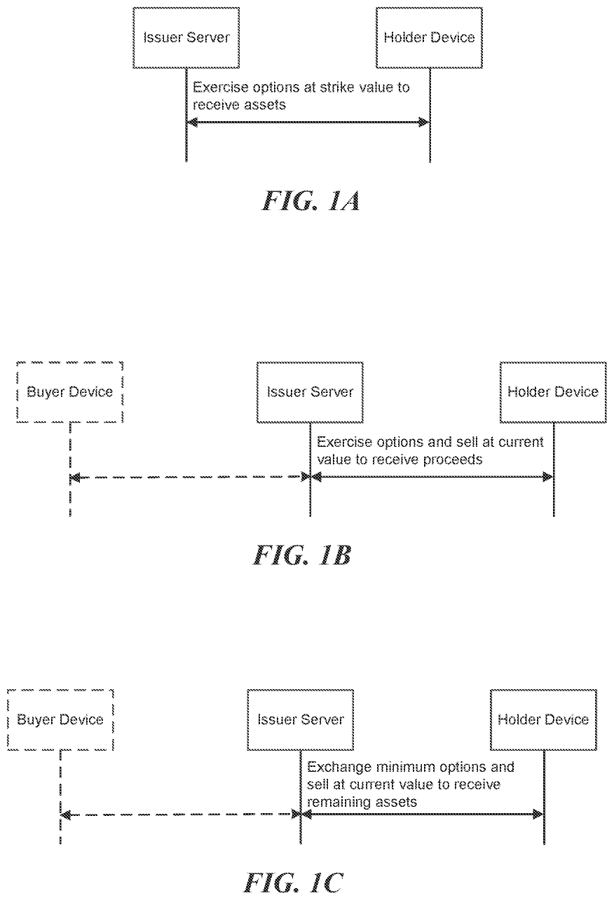

Examples of processes for exercising an option include (i) “exercise and hold,” (ii) “exercise and sell,” and (iii) “sell to cover” processes. FIG. 1A illustrates the exercise and hold process (also referred to as a “cash exercise”). As shown, a holder's user device can communicate with the issuer server to exercise options held by the holder of the options. The user can purchase the underlying assets at the strike value and, in exchange, receive the full number of underlying assets. As such, the user can benefit from any potential future increase of the value of the underlying assets. For example, if the price of an option has a strike value, the holder can purchase the option at the strike value while the underlying asset has a current value different than the strike value. If the current value is greater than the strike value, the delta value (difference) includes proceeds that are allocated to the holder.

FIG. 1B illustrates the exercise and sell process. As shown, the holder's user device can communicate with the issuer server to exercise options and sell the underlying assets at the current value, thereby generating a delta value based on the difference between the strike value and the current value. The assets that are sold exceed the amount required to cover the total cost to exercise all options. The proceeds can thus be sent to the holder user device once all option exercise costs have been paid, including commissions, fees, and taxes. The proceeds from the sale can thus cover the purchase price and additional fees.

FIG. 1C illustrates the sell to cover process. As shown, the holder user device can communicate with the issuer server to exercise options and sell a minimally sufficient number of assets to cover the exercise cost including commissions, fees, and taxes. The holder can then receive the remaining assets in exchange.

The disclosed technology improves over previous processes by enabling a decoupled asymmetric exchange between a purchaser and a holder. As such, holders of proxies to underlying assets can receive proceeds from the sale of the assets without needing to pay to exercise the proxies. Instead, an intermediary service delegates communications that control processes where other parties can pay to exercise the options and buy the underlying assets independent of the holder. The holder can thus receive the proceeds of the sale by posting proxies as virtual assets on an electronic exchange but without ever directly paying to exercise the options. As described later, the service can convert the proxies into virtual assets that are tradable on the electronic exchange. That is, the vested proxies are converted into equivalent assets that are posted for sale during the time-restricted liquidity event. Thus, the vested proxies are treated as assets during the liquidity event for sell intent submission. The holders submit vested proxies as part of sell intent during the event opening period. The platform imposes any restrictions on the assets as well as vested proxies (e.g., maximum 25% vested asset units).

To initiate the process, the service can cause an issuer server to send invitation messages to user device associated with current holders of vested proxies. The invitation messages are communicated serially or in a batch over one or more communications networks to user devices of eligible holders until a predetermined threshold number of holders have accepted the invitation or a threshold number of proxy elements are accepted to post on the electronic exchange. The thresholds can be set to prevent over-loading the electronic exchange with participants.

The invitations can include links that, when clicked, transport the user devices of the holders to a landing page to log into the network portal. The service can administer a network portal for holders to post their vested proxies for sale to other users of the electronic exchange. A particular holder reviews their personal holdings including vested assets and vested proxies from a holder dashboard administered by the intermediary service. In one example, an invitation message includes a link to a form online that requires a signature from an eligible holder to participate in the event. The form can include terms of agreements that are required for participating in the event. In another example, the invitation message can include a control which, when actuated, sends an email including an attached copy of the form for the holder to complete and return to the intermediary. In yet another example, the invitation message includes a link or control that, when clicked or actuated, confirms acceptable of the terms of the agreements in a “single-click” process.

Those holders that are also authorized and eligible to exercise their vested proxies are invited to participate in an event that defines a time-restricted session. The invitation messages can include conditions for participating in the event. Examples of the conditions include being authenticated owners of the proxy elements, which must be vested. The conditions can also include restrictions or constraints on the holders or the proxy assets that can be posted on the electronic exchange. For example, some holders can be precluded from exercising their proxy assets or limit the amount to a fraction of their total holdings and particular periods or points in time.

As such, a holder can exercise and sell proxy assets such that the service or third party pays for the exercise cost from the proceeds of the sale, where the sale is subject to all terms as conditions as set in preexisting agreements. After the event has expired, the delta values are processed and issued as proceeds. Since the exercise of the vested proxies takes place post event expiration, there is no risk of over-exercise. The intermediary service can also generate a holder report to calculate the gross proceeds and cost basis beforehand to inform the holder before agreeing to post the assets.

The issuer receives exercise cost and assists the holders to exercise vested proxies from an existing cap table platform. The issuer can calculate tax withholdings for holder-users who exercise vested proxies during the event. The issuer of the underlying asset can process the holder report and provide deductions (e.g., tax withholdings), if applicable and authorize by the intermediary service for the distribution. The issuer submits the criteria and restrictions to the service, who can generate instructions that delegate communications to an agent server, which is caused to distribute the delta value serially in multiple streams to different parties. In particular, the service can have a preexisting agreement with the agent service to act as an escrow. A first stream of the distribution is for the issuer, to satisfy the exercise cost. A second stream is for the issuer, to satisfy tax withholdings. A third stream is for the service to pay transaction fee, commission fee, and any other service fee. The fourth stream is of the remaining proceeds to the holder. The control is thus bifurcated to handle communications and commands between buyer, agent, issuer, and sellers, and the service delegates communications and commands for the agent to handle allocating proceeds.

System Overview

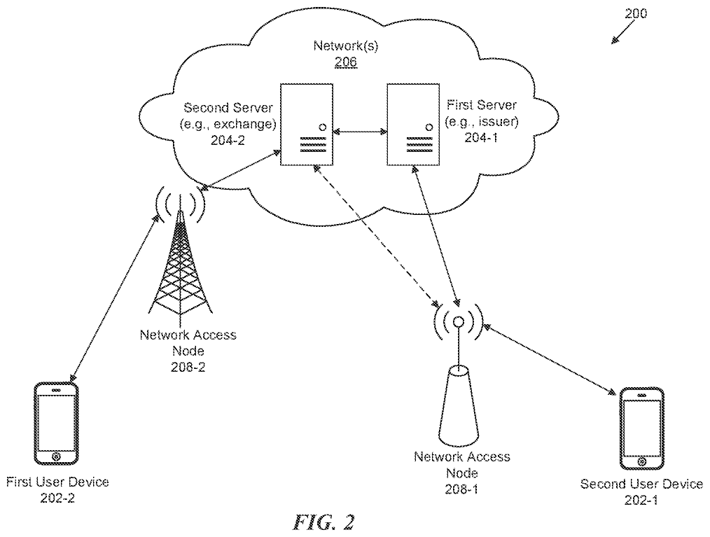

FIG. 2 illustrates a system including servers configured to perform bifurcated control of decoupled asymmetric exchange between devices. The system 200 includes a first user device 202-1 that is communicatively coupled to a first server computer 204-1 over one or more networks 206 via network access node 208-1. A second user device 202-2 is communicatively coupled to a second server computer 204-2 over the one or more networks 206 via the network access node 208-2.

The first user device 202-1 and the second user device 202-2 (referred to collectively as “user devices 202”) can be any type of computing device that can communicate over a wired or wireless communications network with a network node and/or with another computing device over communications network (e.g., computer network, telecommunications network). Examples of the user devices 202 include smartphones, tablet computers, wearable devices, Internet-of-Things (loT) devices, and laptop or desktop computers, servers, or any other computing device that can access the network(s) 206.

The user devices 202 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The network access node 208-1 and the network access node 208-2 (collectively referred to as “network access nodes 208”) can include any type of network node that can communicate with a user device (e.g., user devices 202) and/or with another network node. The network access nodes 208 can include a network device or apparatus. Examples of network access nodes include a base station (e.g., network access node 208-2), an access point (e.g., network access node 208-1), or any other type of network node such as a network controller, radio network controller (RNC), base station controller (BSC), a relay, transmission points, or any other device that can communicate signals over a wired or wireless communications channel. The system 200 depicts different types of network access nodes 208 to illustrate that the user devices 202 can access different types of networks through different types of network access nodes. For example, a base station (e.g., the network access node 208-2) can provide access to a cellular telecommunications system of the network(s) 206. An access point (e.g., the network access node 208-1) includes a transceiver that provides access to a computer system of the network(s) 206.

The network(s) 206 can include any combination of private, public, wired, or wireless systems such as a cellular network, a computer network, the Internet, and the like. Any data communicated over the network(s) 206 can be encrypted or unencrypted at various locations or along different portions of the network(s) 206. Examples of wireless systems include Wideband Code Division Multiple Access (WCDMA), High Speed Packet Access (HSPA), Wi-Fi, Wireless Local Area Network (WLAN), and Global System for Mobile Communications (GSM), GSM Enhanced Data Rates for Global Evolution (EDGE) Radio Access Network (GERAN), 4G, 5G, 6G wireless wide area networks (VVWAN), and other systems that can also benefit from exploiting the scope of this disclosure.

The first server computer 204-1 can include an issuer of proxy elements for underlying assets (e.g., options for underlying equity assets) of private or public entities. In computing technology, a proxy can include a digital representation or intermediary between a requesting resource and the resource itself. As used here, an example of a proxy element includes an option, which is a contract that conveys to its owner, the holder, the right, but not the obligation, to buy or sell an underlying asset or instrument at a specified strike price on or before a specified date, depending on the type of option. Options are typically acquired by purchase, as a form of compensation, or as part of a complex financial transaction. Thus, they are also a form of asset and have a valuation that can depend on a complex relationship between underlying asset value, time until expiration, market volatility, and other factors. Options may be traded between private parties in over-the-counter (OTC) transactions, or they may be exchange-traded in live, orderly markets in the form of standardized contracts.

In one example, a private company can issue options to an employee as part of employment. An example includes an equity option, where the employee can purchase equity in the company after the option has vested. That is, the employee can exchange monetary value for the equity amount indicated in the option. The direct exchange, between the issuer and holder of the option, of money for equity does not require an intervening party. However, the exchange requires that the holder of the option exchange monetary value to exercise the proxy element. Alternatively, an issuer can temporarily hold a number of vested options on behalf of a holder and allow a third party to purchase the underlying assets at a market price, higher than the strike price, such that the proceeds can be returned to the holder or used to purchase the remaining assets that are returned to the holder. In any of these scenarios, the holder of the equity options engages in a direct exchange with the issuer (see, e.g., FIGS. 1A, 1B, 1C). The exchange requires that each party provide something in exchange for something else.

The second server can host a service, application, or platform to exchange proxy elements or assets with participants of a time-restricted session. For example, the second server can host an electronic trading platform (e.g., an electronic exchange) where users can exchange monetary value for assets or proxies of assets. An electronic exchange includes computer software that allows users to place orders for financial products over a network with an intermediary. The products include stocks, bonds, currencies, commodities, derivatives, or digital assets (e.g., cryptocurrencies). The electronic exchange or equivalent are accessible through mobile devices and can provide a website counterpart or Application Programming Interface (API).

As shown and described below, the first server computer can issue proxy elements for the first user device 202-1. The first server computer 204-1 can also communicate with the second server computer 204-2 to post assets on the electronic exchange hosted by the second server computer 204-2. The second user device 202-2 and/or the first user device 202-1 can execute trades on the electronic exchange hosted on the second server computer 204-2.

Bifurcated Control of Decoupled Asymmetric Exchange

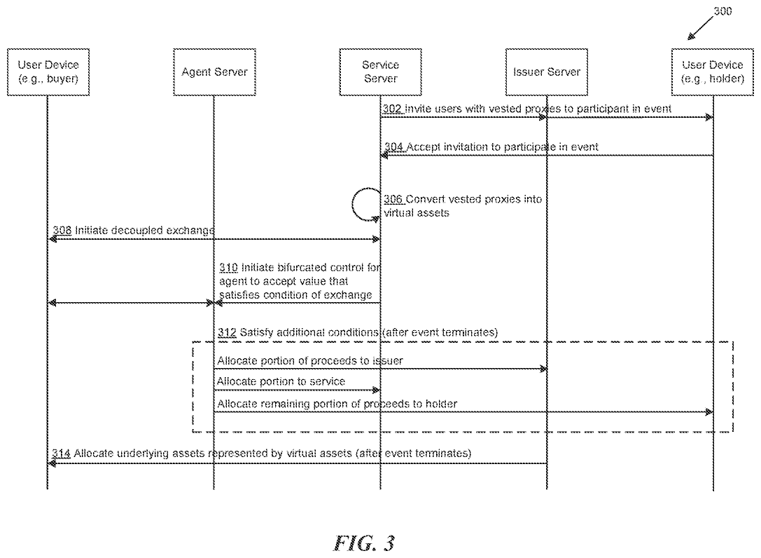

FIG. 3 is a flowchart that illustrates processes including bifurcating control for a decoupled asymmetric exchange between devices. The processes 300 can be performed by a platform or service operating on a system including one or more server computers. The server computers include one or more hardware processors and one or more non-transitory memories storing instructions that, when executed by the hardware processors, cause the system to perform the processes 300. Examples of the servers include the server that issues the proxy elements (“elements”) and a server that hosts an electronic exchange. User devices are operated by the holder of the elements or the buyer of virtual assets on the electronic exchange.

At 302, the system can cause a first server computer to send a query message over a computer network to a first user device for a user (e.g., holder) to join an event including a temporary session hosted by a second server computer, such as an event hosted on an electronic exchange. In one example, the first server computer issues private equity options and the second device operates the electronic exchange to trade virtual assets that represent the vested private equity options to third parties. The system can select multiple users including the first user as having vested elements available for divesting and cause the first server computer to send queries to user devices of the users to join the event hosted at the second server computer. For example, the service can obtain information about holders of private equity options that have vested and, as such, can be exercised by the holder.

The service can cause the issuer to email or otherwise communicate with user devices to invite holders to participate in the time-restricted session hosted by the second server computer. The time-restricted session can correspond to a period where participants can trade virtual assets on the exchange, where the virtual assets represent vested proxy elements. The virtual assets are tradable like regular assets on the electronic exchange environment. The first server computer authenticates the first user as having elements that are vested proxies to assets. The query that is sent to the user device can include a link to route the first user device to the electronic exchange administered by the second server computer and enables the user to post their elements on the electronic exchange.

At 304, the system can receive a request at the second server computer from the user device to join the temporary session and post elements on the electronic exchange. In one example, the holder's elements include unvested proxy assets and vested proxy assets, and the holder is authorized to post only the vested proxy assets on the electronic exchange (e.g., not the unvested proxy assets). In one example, the system can generate an electronic report including an expected equity value of each asset and send the electronic report to the user device, to inform the holder beforehand about an estimated value of the underlying assets and the opportunity to trade the options on the electronic exchange.

In one example, the electronic exchange administered by the second server computer enables trading of private equities. The electronic exchange can include a user interface configured to present profiles of users having elements, and is configured to receive input from users to purchase virtual assets. The assets of the elements posted on the electronic exchange are available to allocate to users after the temporary session has expired, without divesting the elements until one or more conditions are satisfied. The conditions can include monetary value that are provided to purchase the virtual assets, and streaming components of the monetary value to the user device of the holder, the first server computer, and the second server computer.

At 306, the system converts the elements (e.g., vested proxy assets) into virtual assets that are exchangeable for monetary values with authorized users of the electronic exchange. In one example, the system determines a set of elements that are proxies to assets associated with a holder, identifies a subset of elements that vested and unrestricted for exchange during the temporary session, and converts only the subset of elements into the virtual assets. The virtual assets are posted and available for purchase by third parties that are authorized and authenticated to participate in the temporary session. In one example, the vested proxies of assets are converted to the virtual assets that represent equity assets. Thus, the virtual assets can be temporary representations of elements and are configured for exchange for an equity value on the second server computer independent of the holder's user device. In one example, the virtual assets of corresponding elements are exchangeable on the electronic exchange for a particular value per asset. Hence, the virtual assets are allocatable in exchange for a current value per asset different than the original value. The value is thus a requirement or condition that must be satisfied to trade the virtual assets.

At 308, the system delegates the second server computer to perform a decoupled asymmetric exchange based on the virtual assets over separate communications channels/links. One channel/link is between the second user device (e.g., purchaser/buyer) and the second server computer (e.g., host of the electronic exchange) and the other channel/link is between the second user device and the first server computer (e.g., issue of the proxy assets). An agent server is bifurcated by the second server computer to control the decoupled asymmetric exchange, accept values for the virtual assets, and route communications over the separate channels/links to satisfy conditions required to allocate the underlying assets to the second user device.

At 310, the system delegates the agent server to receive input from the second device satisfying a first condition to transfer the virtual assets from the holder to the purchaser. An example of the first condition includes a monetary value corresponding to the current/estimate value of the underlying assets being represented by the virtual assets. After the event closes (e.g., the temporary session ends), the agent server can operate to satisfy additional conditions that are required before the underlying assets can be allocated to the purchaser. In one example, the first condition includes filling an equity value corresponding to a difference between a current equity value of each asset and a strike equity value of each asset. That is, the strike equity value is an initial value assigned to each asset upon assignment to the trader and the current equity value is an estimate equity value of the asset at or about a time when the decoupled exchange is performed.

At 312, the system can cause the agent server to satisfy subsequent conditions for the first server computer and the first user device. In particular, after expiration of the event, proceeds of the decoupled asymmetric event are used to pay the issuer (satisfy a condition), pay any taxes and fees (satisfy another condition), and pay fees taken by the electronic exchange (satisfy another condition). The remaining proceeds are given to the holder of the proxy assets at the user device of the holder (satisfy another condition). For example, after expiration of the event, the agent server serially streams portions of the monetary value paid by the purchaser to the first server computer, the second server, and the first user device. The portions can be streamed serially in that particular order or another order.

At 314, after expiration of the event and after satisfying the required conditions, the system can cause the first server computer to allocate the assets of the elements converted to the virtual assets from the first server computer to the second user device. Hence, the exchange occurs independent of the first user device of the holder and the second server computer hosting the electronic exchange. Thus, the assets are allocated only after the first, second, third, and any other conditions are satisfied, and only after the event ended (e.g., temporary session expired). In one example, the assets are transferred from the first user to the second user anonymously through the second server computer.

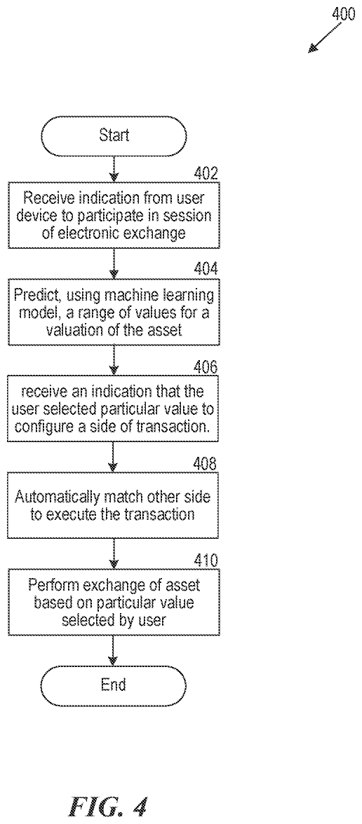

FIG. 4 is a flowchart that illustrates processes performed by a matching engine to perform an exchange between systems. The matching engine can predict valuations for assets or orders that are then used to inform users, match buy and sell orders of assets, and execute transactions. The matching engine enables scalability by removing cost-prohibitive manual processing, which increases the liquidity of the electronic exchange to increase participants in events hosted by the platform of the system.

The platform can present an interface on a user device and include controls and information that provides a guided experience for a participant to submit an entry point price according to rules that are set by a host, issuer, etc. In one example, a user enters a target price for an asset of a trade executed at an event. The target price is entered to organize trades before entering a regulatory system for executing the trades. The platform can validate the target price against trade limits, price minimums, and other parameters set for the event by the host, the issuer of the asset, etc. The target price is promoted to an ATS and used to perform automatic matching of orders, if possible.

The user can thus choose a target price and number of share assets that the user wants to sell during a session hosted on the platform. In one example, a user has the option to sell up to ten percent of vested stock or options. When ready, the user submits the trade intent to the platform, which guides the user through processes to complete the trade.

The interface can present a price guide for a valuation of one or more assets that represent equity of an organization. The price guide can be predicted based on prior funding rounds used to predict a price and/or a range between minimum and maximum valuations. A predicted price guide can be generated based on a variety of historical data including prior trades on the platform performed over a predetermined period for the same or other assets that have similar priorities or have analogous features including being in a particular market segment or market performance of related companies from which the assets for a particular company of interest. The price guide can be bounded by an issuer's minimum price.

For the sell side, the platform includes functionality to select and control software programs that automate broker operations. If more than one broker, the seller accounts created during an event can be distributed across multiple brokers. Existing client users who already have an account and a broker previously assigned can be assigned to a new program broker. For the buy side, the platform has functionality to create accounts for the sell-side participants and leverages existing market sign-up and account creation flow for the buy-side. A special flag or indicator is added during the buy-side IOI submission. The platform can assign the program broker for the buy-side participants post sign up/account creation. The buy-side participants should be assigned to a designated program broker.

A participant sell intent is posted on an IOI queue system for validation. That is, the seller submits the IOI at a market level via a dashboard of the platform. A market level sell intent can be placed directly into a broker IOI queue. More specifically, a seller accepts an invention and lands on the dashboard of the platform. The system can present the seller with a price guide prior to the sell intent submission. The seller enters the sell intent from the dashboard, and a rules-based mechanism that mimics the checks that a broker puts in place. For example, if a predicted market price is set between $10-$12, the participants cannot submit a sell intent less than $10 or higher than $12. Differing from the market platform process where client's sell intents are manually reviewed by brokers in their pending interest queue, the platform sell intent will skip the pending interest queue and place directly onto the broker IOI queue. The virtual brokers can see the sell IOI in the IOI queue.

The automated matching reduces or removes transaction limits, which increases the event liquidity. In particular, private trading normally has low liquidity due to human processing required to match particular orders. That is, any order must exceed a threshold value (e.g., total price) due to cost-prohibitive human intervention. In particular, many potential participants are prohibited from events because they cannot be met or exceed the threshold. As a result, a barrier for lower trades sizes (e.g., volumes) and transaction limit (e.g., value) is imposed. The matching engine can thus increase liquidity with numerous (e.g., hundreds, thousands) of small shareholders that can submit small sell intents to be aggregated to fulfill a sell side. As a result, the number of shareholders that can participate in an event is removed or reduced. The platform can perform share conversion to issue new shares of one type without needing the issuer to cancel and reissue other types of shares. For example, the system can convert from preferred shares to common shares, preferred A to preferred B, or any other share conversion combination. The issuer thus does not need to cancel a preferred stock A to reissue common stock. Instead, the system can receive preferred share A issued by the issuer and convert the shares to common shares.

The valuations presented in a price guide are predicted from one or more machine learning (ML) models. A “model,” as used herein, can refer to a construct that is trained using training data (e.g., historical valuation data) to make predictions or provide probabilities for new data items (e.g., new valuations), regardless of whether the new data items were included in the training data. For example, training data for supervised learning can include valuations with various parameters and an assigned classification. As such, a valuation can have parameters that a model can use to assign a classification to the new valuation. As an example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the matching engine can include a neural network with multiple input nodes that receive valuation data. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used as an updated or new valuation for the same asset or similar type of asset. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A model can be trained with supervised learning, where the training data includes valuation parameters as input and a desired output, such as historical valuations of assets. A representation of valuations can be provided to the model. Output from the model can be compared to the desired output for that valuation and, based on the comparison, the model can be modified, such as by changing weights between nodes of the neural network or parameters of the functions used at each node in the neural network (e.g., applying a loss function). After applying each of the valuations in the training data and modifying the model in this manner, the model can be trained to evaluate new valuations.

At 402, the system receives an indication from a user of a user device to participate in a temporary session of an electronic exchange hosted by the system. The indication includes an indication of interest to perform a transaction between the user and at least one participant of the session. The transaction can include an exchange of an asset that represents an equity value for an entity. In one example, the electronic exchange administered by a server computer corresponds to an electronic exchange of private equities, where the electronic exchange includes a user interface configured to present valuations for assets of entities and is configured to receive input from users to transact based on the assets.

At 404, the system can predict, as an output of a ML model, a range of values for a valuation of the asset. The ML model is trained based on data of multiple assets that represent equities for different entities. In one example, the range of values for the valuation is bounded by a maximum value or a minimum value. The system can generate the ML model based on prior valuations of the multiple assets that represent equities for the different entities over a predetermined period of time. The host, a broker, or the issuer can configure the range to be bounded by a maximum value and a minimum value. Further, the system trains the ML model to bias valuations for a group of entities toward the particular value more than other values of the range of values. In one example, the group of entities is defined as such based on having one or more features in common (e.g., belong to a common market segment).

At 406, the system can receive an indication that the user selected a particular value of the range of values to configure a first side of the transaction. The range of values is presented on a display device of the user device for selection by the user to configure the first side of the transaction. In one example, the system can cause an interface of the user device to present a price guide for the valuation of the asset. The price guide includes a range of prices that are each selectable by the user to set a target valuation for the user. The system can predict the price guide including a range between minimum and maximum valuations. In one example, the price guide is predicted based on prior funding rounds for the entity. The price guide is predicted based on a variety of historical data including prior trades on the platform performed over a predetermined period for the same or other assets that have similar priorities or have analogous features including being in a market segment or performance of entities including the entity. The system can predict the range between minimum and maximum valuations.

At 408, the system can automatically match a second side for the transaction with the first side of the transaction. The second side includes one or more participants of the temporary session hosted by the server computer. For example, the system can aggregate a group of users that collectively form the second side of the transaction that matches first side of the transaction. The system can convert from the asset from the first type of share to a second type of share without canceling the first type of share.

At 410, the system can perform an exchange of the asset between the first side and the second side of the transaction based on the selected value of the range of values. The asset is allocated upon expiration of the temporary session.

Computer System

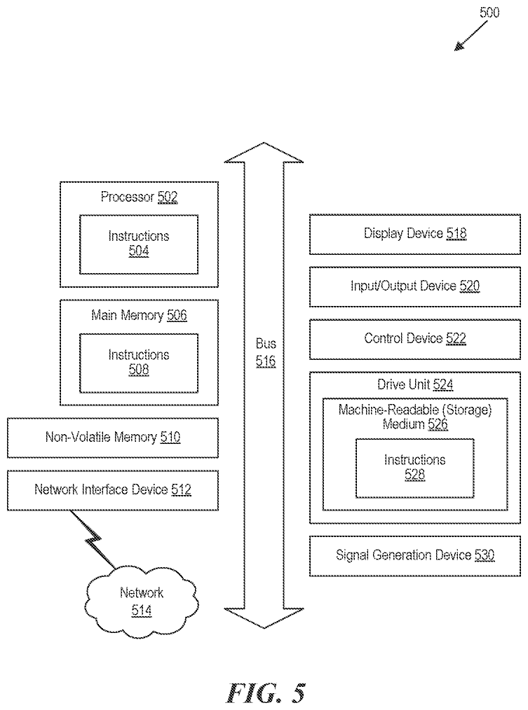

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A system including a matching engine comprising:
at least one hardware processor; and
at least one non-transitory memory storing instructions, which, when executed by the at least one hardware processor, cause the system to:
receive an indication from a user of a user device to participate in a temporary session of an electronic exchange hosted by the system,
wherein the indication includes an indication of interest to perform a transaction between the user and at least one participant of the temporary session, and
wherein the transaction includes an exchange of an asset that represents an equity value for an entity;
predict, as an output of a machine learning (ML) model, a range of values for a valuation of the asset,
wherein the ML model is trained based on data of multiple assets that represent equities for different entities, and
wherein the range of values for the valuation is bounded by a maximum value or a minimum value;
receive an indication that the user selected a particular value of the range of values to configure a first side of the transaction,
wherein the range of values is presented on a display device of the user device for selection by the user;
automatically match a second side for the transaction with the first side of the transaction,
wherein the second side includes one or more participants of the temporary session hosted by the system; and
perform an exchange of the asset between the first side and the second side of the transaction based on the particular value of the range of values, wherein the asset is allocated upon expiration of the temporary session.

2. The system of claim 1 further caused to:
generate the ML model based on prior valuations of the multiple assets that represent equities for the different entities over a predetermined period of time,
wherein the range is designated by an issue of the asset to be bounded the maximum value and the minimum value.

3. The system of claim 1 further caused to:
train the ML model to bias valuations for a group of entities toward the particular value more than other values of the range of values,
wherein the group of entities have at least one feature in common with the entity.

4. The system of claim of claim 1, wherein to match the first and second sides of the transaction comprise causing the system to:
aggregate a group of users that collectively form the second side of the transaction.

5. The system of claim 1:
wherein the electronic exchange corresponds to an electronic exchange of private equities, and
wherein the electronic exchange includes a user interface configured to present valuations for assets of entities and is configured to receive input from users to transact based on the assets.

6. The system of claim 1 further caused to:
cause an interface of the user device to present a price guide for the valuation of the asset,
wherein the price guide includes a range of prices that are each selectable by the user to set a target valuation for the asset.

7. The system of claim 6 further caused to:
predict the price guide including a range between minimum and maximum price valuations,
wherein the price guide is predicted based on prior funding rounds for the entity.

8. The system of claim 6 further caused to:
predict the price guide including a range between minimum and maximum price valuations,
wherein the price guide is predicted based on historical data including prior trades performed using the system over a predetermined period for assets that have common priorities, belonging to a common market segment, or having common performance values for entities.

9. The system of claim 6, wherein the price guide is bounded by a minimum price of the asset configured by an issuer of the asset.

10. The system of claim 1, wherein the asset is a first type of share, the system further caused to:
convert the asset from the first type of share to a second type of share without canceling the first type of share.

11. A computer-readable storage medium, excluding transitory signals and carrying instructions, which, when executed by at least one data processor of a system, cause the system to:
receive an indication from a user of a user device to participate in an electronic exchange hosted by the system,
wherein the indication includes an indication of interest to perform a transaction between the user and at least one participant of the electronic exchange, and
wherein the transaction includes an exchange of an asset that represents an equity value for an entity;
predict, as an output of a machine learning (ML) model, a range of values for a valuation of the asset,
wherein the ML model is trained based on data of multiple assets that represent equities for different entities, and
wherein the range of values for the valuation is bounded by a maximum value or a minimum value;
receive an indication that the user selected a particular value of the range of values to configure a first side of the transaction;
automatically match a second side for the transaction with the first side of the transaction,
wherein the second side includes one or more participants of the electronic exchange hosted by the system; and
perform an exchange of the asset between the first side and the second side of the transaction based on the particular value of the range of values.

12. The computer-readable storage medium of claim 11, wherein the system is further caused to:
generate the ML model based on prior valuations of the multiple assets that represent equities for the different entities over a predetermined period of time.

13. The computer-readable storage medium of claim 11, wherein the system is further caused to:
train the ML model to bias valuations for a group of entities toward the particular value,
wherein the group of entities have at least one feature in common with the entity.

14. A method performed by a matching engine operating on one or more server computers comprising, the method comprising:
receiving an indication from a user of a user device to participate in a temporary session of an electronic exchange hosted by a system including the matching engine,
wherein the indication includes an indication of interest to perform a transaction between the user and at least one participant of the temporary session, and
wherein the transaction includes an exchange of an asset that represents an equity value for an entity;
receiving an indication that the user selected a particular value of a range of values to configure a first side of the transaction,
wherein the range of values is presented on a display device of the user device for selection by the user;
automatically matching a second side for the transaction with the first side of the transaction,
wherein the second side includes one or more participants of the temporary session hosted by the server computer; and
performing an exchange of the asset between the first side and the second side of the transaction based on the particular value of the range of values,
wherein the asset is allocated upon expiration of the temporary session.

15. The method of claim 14 further comprising:
predicting, using a machine learning (ML) model, a range of values for a valuation of the asset,
wherein the ML model is trained based on data of multiple assets that represent equities for different entities, and
wherein the range of values for the valuation is bounded by a maximum value or a minimum value.

16. The method of claim 14, wherein to match the first and second sides of the transaction comprises:
aggregating a group of users that collectively form the second side of the transaction.

17. The method of claim 14:
wherein the electronic exchange corresponds to an electronic exchange of private equities, and
wherein the electronic exchange includes a user interface configured to present valuations for assets of entities and is configured to receive input from users to transact based on the assets.

18. The method of claim 14 further comprising:
causing an interface of the user device to present a price guide for a valuation of the asset,
wherein the price guide includes a range of prices that are each selectable by the user to set a target valuation for the asset.

19. The method of claim 18 further comprising:
predicting the price guide to include a range between minimum and maximum valuations,
wherein the price guide is predicted based on prior funding rounds for the entity.

20. The method of claim 18 further comprising:
predicting the price guide including a range between minimum and maximum valuations,
wherein the price guide is predicted based on historical data including prior trades performed using the system over a predetermined period for a group of assets.
